(19) United States
(12) Patent Application Publication
(10) Pub. No.: US 2026/0269896 A1
(43) Pub. Date: Sep. 10, 2026

(54) ASYMMETRIC COORDINATED BEAM FORMING MULTI-ACCESS POINT SCHEMES IN WIRELESS COMMUNICATIONS

(71) Applicant: MEDIATEK INC., Hsinchu City (TW)

(72) Inventors: Shuling FENG, San Jose, CA (US); Jianhan LIU, San Jose, CA (US); Gary A. ANWYL, San Jose, CA (US); Thomas Edward PARE, Jr., San Jose, CA (US); Weisung TSAO, San Jose, CA (US); Chung-Ta KU, San Jose, CA (US); Po-Yuen CHENG, San Jose, CA (US); Samat SHABDANOV, San Jose, CA (US)

(21) Appl. No.: 19/167,737

(22) PCT Filed: Aug. 16, 2024
(86) PCT No.: PCT/CN2024/112580

§ 371 Date: Sep. 22, 2025

Related U.S. Application Data
(60) Provisional application No. 63/520,108, filed on Aug. 17, 2023.
(60) Provisional application No. 63/584,518, filed on Sep. 22, 2023.

(51) Int. Cl. H04B 7/06; H04B 7/024; H04B 7/26

(52) U.S. Cl. CPC H04B 7/0617; H04B 7/024; H04B 7/2656

(57) ABSTRACT

Various techniques pertaining to asymmetric coordinated beam forming multi-access point (multi-AP) schemes in wireless communications are described. An apparatus (e.g., a sharing access point (AP)) transmits a trigger frame (TF) to one or more shared APs to trigger a coordinated multi-access point (CMAP) transmission. The apparatus then participates in the CMAP transmission with the one or more shared APs. The TF includes an information field that signals a coordination mode for the CMAP transmission and mode-dependent information.

### CROSS REFERENCE TO RELATED PATENT APPLICATION

The present disclosure is part of a non-provisional patent application claiming the priority benefit of U.S. Provisional Patent Application Nos. 63/520,108 and 63/584,518, filed 17 Aug. 2023 and 22 Sep. 2023, respectively, the contents of which herein being incorporated by reference in their entirety.

### TECHNICAL FIELD

The present disclosure is generally related to wireless communications and, more particularly, to asymmetric coordinated beam forming (CBF) multi-access point (multi-AP) schemes in wireless communications.

### BACKGROUND

Unless otherwise indicated herein, approaches described in this section are not prior art to the claims listed below and are not admitted as prior art by inclusion in this section.

In wireless communications such as WiFi (or Wi-Fi) and WLANs under the Institute of Electrical and Electronics Engineers (IEEE) 802.11 specifications, coordinated spatial reuse (CSR) and coordinated beam forming (CBF) are proposed as coordinated multi-AP (MAP) transmission schemes for next-generation WLANs. Both MAP-CSR and MAP-CBF schemes allow multiple APs to transmit signals to stations (STAs) simultaneously on the same frequency band. Both schemes intend to reduce interferences from other APs. There may be two or more APs participating in each of the MAP-CSR scheme and MAP-CBF scheme, and each AP may serve multiple users/STAs. In MAP-CSR, with coordinated efficient rate adaptation and accurate transmission power control, each AP transmits just enough power toward its targeted STAs to meet signal-to-interference-and-noise ratio (SINR) requirement while not causing excessive interferences to STAs targeted by other APs. In MAP-CBF, with adequate antenna resources, each AP beamforms transmission signals toward its targeted STAs and nulls transmission signals toward STAs targeted by other APs.

However, at the time of the invention of the present disclosure, there is not yet a mechanism for a sharing AP and corresponding shared AP(s) in a MAP to exchange certain information that would help improve network throughput if such information was exchanged between/among the sharing AP and shared APs. Therefore, there is a need for a solution of asymmetric (or lightly) CBF MAP schemes in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to asymmetric CBF MAP schemes in wireless communications. The asymmetric CBF schemes proposed herein may be interchangeably referred to as lightly CBF (LCBF) and/or asynchronous CBF (A-CBF) schemes. It is believed that various schemes proposed herein may address or otherwise alleviate the aforementioned issue(s).

In one aspect, a method may involve a processor of a sharing AP transmitting a trigger frame (TF) to one or more shared APs to trigger a coordinated multi-access point (CMAP) transmission. The method may also involve the processor participating in the CMAP transmission with the one or more shared APs. The TF may include an information field that signals a coordination mode for the CMAP transmission and mode-dependent information.

In another aspect, a method may involve a processor of a shared AP receiving a TF from a sharing AP that triggers a CMAP transmission. The method may also involve the processor participating in the CMAP transmission with the sharing AP. The TF may include an information field that signals a coordination mode for the CMAP transmission and mode-dependent information.

It is noteworthy that, although description provided herein may be in the context of certain radio access technologies, networks and network topologies such as, WiFi/WLAN, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example design under a proposed scheme in accordance with the present disclosure.

FIG. 7 is a diagram of an example scenario under a proposed scheme in accordance with the present disclosure.

FIG. 8 is a block diagram of an example communication system under a proposed scheme in accordance with the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to asymmetric (or lightly) CBF MAP schemes in wireless communications. According to the present disclosure, a number of possible solutions may be implemented separately or jointly. That is, although these possible solutions may be described below separately, two or more of these possible solutions may be implemented in one combination or another.

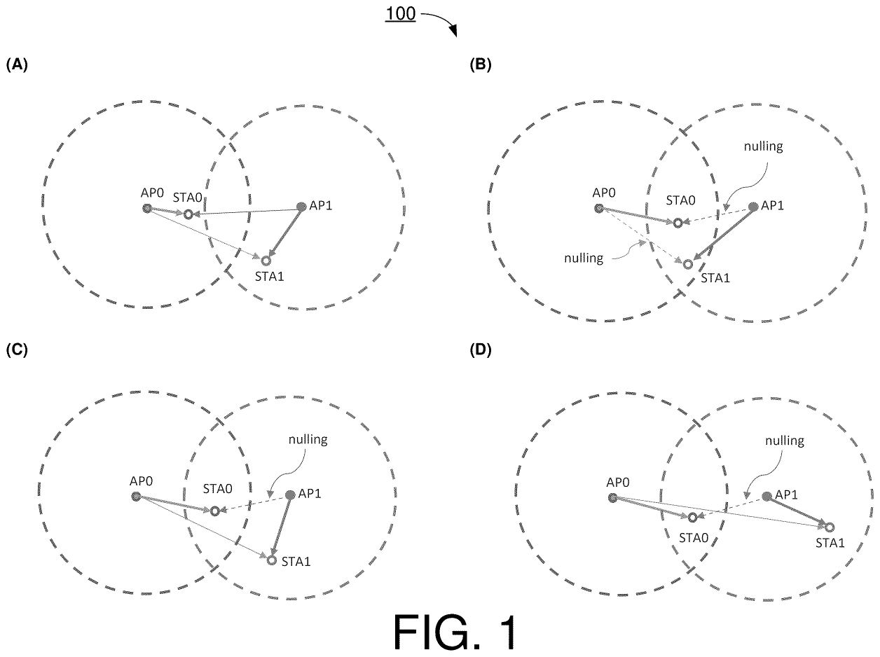

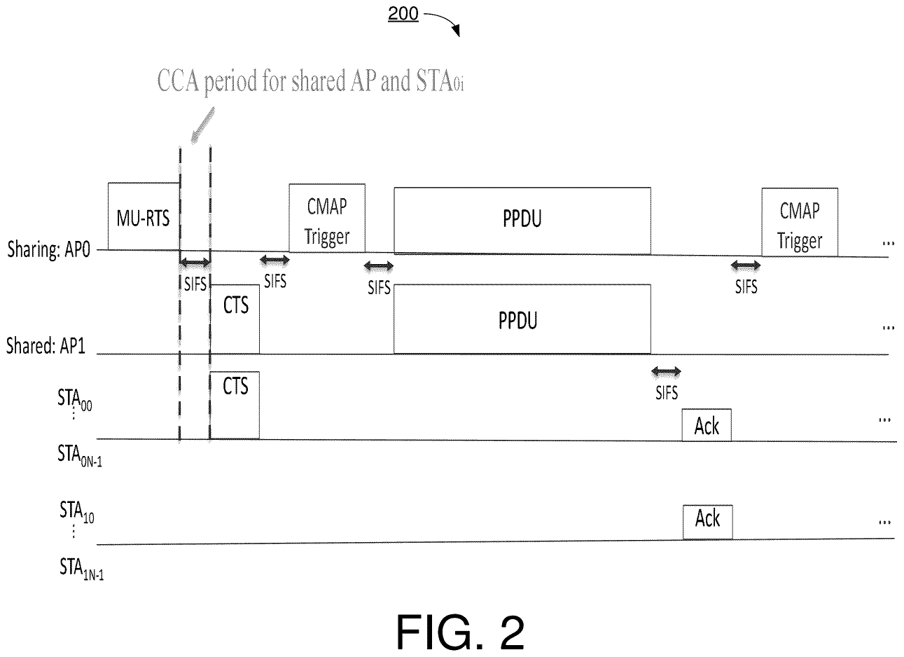

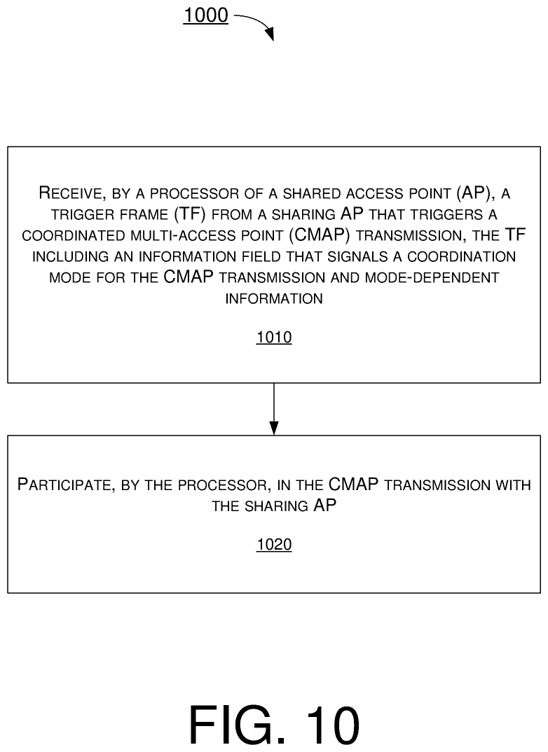

FIG. 1 illustrates an example network environment 100 in which various solutions and schemes in accordance with the present disclosure may be implemented. FIG. 2~FIG. 10 illustrate examples of implementation of various proposed schemes in network environment 100 in accordance with the present disclosure. The following description of various proposed schemes is provided with reference to FIG. 1~FIG. 10.

Network environment 100 may involve multiple APs (e.g., AP0 and AP1) communicating wirelessly with respectively associated STAs (e.g., STA0 and STA1). AP0 may be a transmission opportunity (TXOP) sharing AP and AP1 may be a shared AP (with which AP0 shares a portion of the TXOP). Moreover, in network environment, AP0 may serve STA0 (e.g., STA0 being the targeted STA of AP0) and AP1 may serve STA1 (e.g., STA1 being the targeted STA of AP1). In the present disclosure, the term “sharing AP” refers to an AP that acquires a TXOP and shares a portion of the TXOP with one or more other APs (herein referred to as “shared APs”). Each AP (herein interchangeably referred to as “AP STA”) and each STA (herein interchangeably referred to as “non-AP STA”) may be configured to communicate with each other by utilizing the various proposed schemes described below. For instance, each of AP0, AP1, STA0 and STA1 may be configured to perform wireless communications with asymmetric (or lightly) CBF MAP schemes as described below. For the sake of simplicity, two APs (and each serving one associated STA) are shown in FIG. 1, although in various implementations under the proposed schemes may involve more APs and more STAs. Part (A) of FIG. 1 shows an example scenario of MAP-CSR. Part (B) of FIG. 1 shows an example of MAP-CBF. Each of part (C) and part (D) of FIG. 1 shows a respective example scenario of MAP-LCBF under the proposed schemes. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In the MAP-CSR example shown in part (A) of FIG. 1, STA0 may be much closer to AP0 than STA1, and STA1 may be much closer to AP1 than STA0. AP0 and AP1's transmission powers may be coordinated to meet SINR requirements at STA0 and STA1. In the example shown in part (B) of FIG. 1, STA0 and STA1's distance from AP0 and AP1 may be close. It may be difficult if not possible to have performance gain in CSR. In this case, with adequate antenna resources, CBF may be applied to achieve network throughput gain with AP0 nulling to STA1 and AP1 mulling to STA0.

In the examples shown in parts (C) and (D) of FIG. 1, each of the STAs may be close to their own serving APs, but STA0 may be close to AP1 while STA1 may be far away from AP0. The interference AP0 causes to STA1 may be weak enough to not degrade its SINR significantly, but interference AP1 causes to STA0 may be strong enough to significantly degrade its SINR. Therefore, AP1 may need to null its transmission toward STA0, while AP0 may not need to perform nulling to STA1. In each of parts (C) and (D) of FIG. 1, in case that CSR is applied, AP1 may need to significantly reduce its transmission power in order to reduce interference to STA0. As a result, CSR may not achieve through put gain. Moreover, in each of parts (C) and (D) of FIG. 1, CBF with full mulling may not be necessary due to low interference at STA1, high complexity and requirement of extra antenna to perform nulling by sharing AP0.

FIG. 2 illustrates an example scenario 200 under a proposed scheme in accordance with the present disclosure. Scenario 200 may pertain to a first coordinated multi-AP (CMAP) transmission procedure (CMAP transmission procedure 1). Referring to FIG. 2, AP0, as the sharing AP, may transmit a multi-user request-to-send (MU-RTS) frame and, in response, AP1, as a shared AP, may, along with the STAs served by AP0, transmit a clear-to-send (CTS) frame to respond to AP0. Then, AP0 may transmit a CMAP trigger frame to trigger a CMAP transmission. Next, each of AP0 and AP1 may transmit a respective physical-layer protocol data unit (PPDU) to its targeted STA(s). In response, each of the STAs may transmit an acknowledgement (ACK) frame. Subsequently, AP0 may initiate additional CMAP transmission(s) with new CMAP trigger frame(s).

In scenario 200, the MU-RTS and CTS exchange may be performed once at the beginning of the TXOP. Shared AP(s) may perform clear channel assessment (CCA) during a period of short interframe space (SIFS). To be fair, the shared AP(s) should only perform such SIFS CCA within the bandwidth used by the sharing AP. Therefore, the bandwidth used by a shared AP (e.g., AP1) may be equal to or smaller than that used by the sharing AP (e.g., AP0). The CMAP trigger frame (TF) may contain STA profiles, shared AP transmission mode(s), and requirements of shared AP transmission. Under the proposed scheme, a CMAP Info field in the CMAP TF may be utilized for this purpose. Moreover, the CMAP trigger frame(s) in the frame exchange procedure in scenario 200 may carry signaling of CMAP modes.

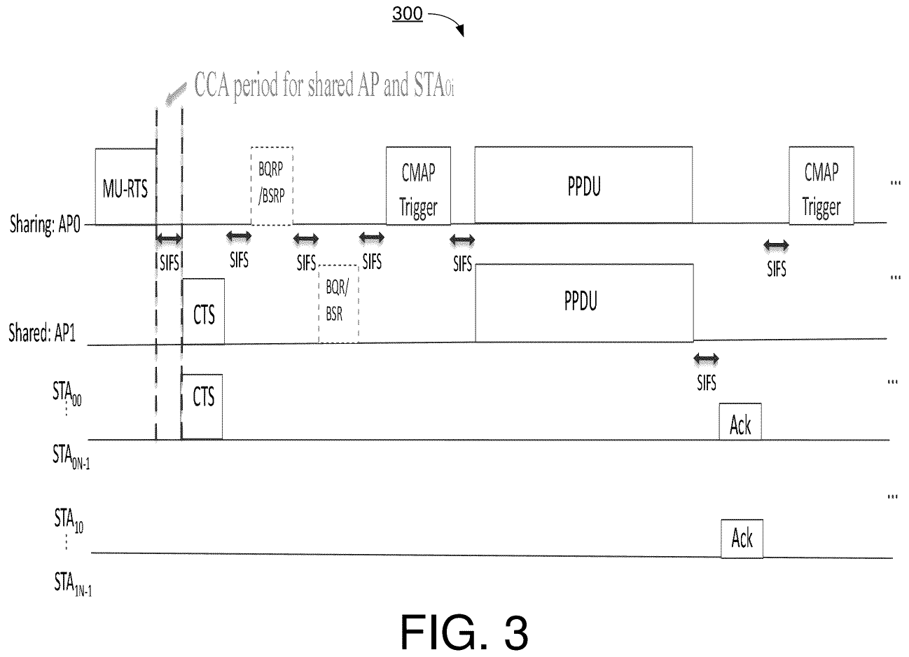

FIG. 3 illustrates an example scenario 300 under a proposed scheme in accordance with the present disclosure. Scenario 300 may pertain to a second CMAP transmission procedure (CMAP transmission procedure 2). Referring to FIG. 3, AP0, as the sharing AP, may transmit a MU-RTS frame and, in response, AP1, as a shared AP, may, along with the STAs served by AP0, transmit a CTS frame to respond to AP0. Then, AP0 may transmit a buffer status report poll (BSRP) or bandwidth query report poll (BQRP) and, in response, AP1, as a shared AP, may transmit a buffer status report (BSR) or bandwidth query report (BQR) to AP0. Then, AP0 may transmit a CMAP trigger frame to trigger a CMAP transmission. Next, each of AP0 and AP1 may transmit a respective PPDU to its targeted STA(s). In response, each of the STAs may transmit an ACK frame. Subsequently, AP0 may initiate additional CMAP transmission(s) with new CMAP trigger frame(s).

In scenario 300, since multi-user clear-to-send (MU-CTS) cannot indicate to the sharing AP what bandwidth the shared AP can use, the exchange of BSRP/BQRP and BSR/BQR may also be necessary before the CBF data transmission so as to signal to the sharing AP about the bandwidth(s) of the shared AP(s). It is noteworthy that, BSRP/BQRP and BSR/BQR, or any similar type of frames, may be optionally utilized to convey information and parameters of STAs served by AP0 as well as information and parameters of STAs served by AP1. Moreover, BSRP/BQRP and BSR/BQR, or any similar type of frames, may also be optionally utilized before CMAP transmission in the TXOP. Thus, under the proposed scheme, a new type of frame may be utilized to contain and convey information and parameters mentioned above in BSRP and BQRP. Correspondingly, a new type of frame may be utilized to contain and convey information and parameters mentioned above in BSR and BQR. Moreover, the CMAP trigger frame(s) in the frame exchange procedure in scenario 300 may carry signaling of CMAP modes.

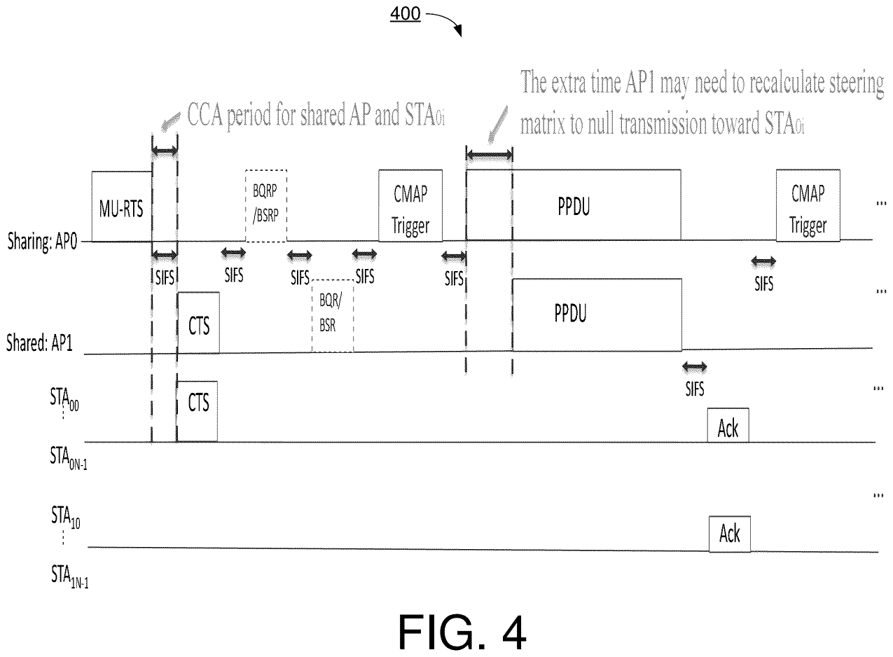

FIG. 4 illustrates an example scenario 400 under a proposed scheme in accordance with the present disclosure. Scenario 400 may pertain to a third CMAP transmission procedure (CMAP transmission procedure 3). Referring to FIG. 4, AP0, as the sharing AP, may transmit a MU-RTS frame and, in response, AP1, as a shared AP, may, along with the STAs served by AP0, transmit a CTS frame to respond to AP0. Then, AP0 may transmit a BSRP or BQRP and, in response, AP1, as a shared AP, may transmit a BSR or BQR to AP0. Then, AP0 may transmit a CMAP trigger frame to trigger a CMAP transmission. Next, each of AP0 and AP1 may transmit a respective PPDU to its targeted STA(s). In response, each of the STAs may transmit an ACK frame. Subsequently, AP0 may initiate additional CMAP transmission(s) with new CMAP trigger frame(s).

Different from scenario 300, in scenario 400, AP1 may transmit its PPDU at a certain time after AP0 transmits its PPDU. This extra time may be utilized by AP1 to recalculate its steering matrix to null transmission toward STA0 (and any other STA(s) served by AP0). That is, AP1 may delay the transmission of its PPDU due to the recalculation of steering matrix. In such a case, AP1 may not indicate to AP0 the TF extension it needs for CBF recalculation, or the CBF TF extension added in CMAP TF may not be long enough. Thus, under the proposed scheme, such an issue may be addressed as described below. Moreover, the CMAP trigger frame(s) in the frame exchange procedure in scenario 400 may carry signaling of CMAP modes.

Under a proposed LCBF MAP scheme, which may be applied in scenarios 200, 300 and 400 in the context of parts (C) and (D) of FIG. 1, the sharing AP (e.g., AP0) may not need to perform nulling to STAs served by other APs (e.g., AP1). Under the proposed scheme, MAP-LCBF may be negotiated between the sharing AP and shared AP(s) when certain conditions are met. Such conditions may include, for example, AP0 and AP1 have sounded their served STAs (e.g., STA0 and STA1). Also, AP0 may own the TXOP and may have a list of served STAs. Moreover, AP0 may assess that the interference by AP1 on the STA(s) served by AP0 needs to be nulled. Furthermore, AP1 may assess that the interference by AP0 on the STA(s) served by AP1 may be weak enough to be tolerated. Alternatively, or additionally, AP1 may adapt the data rate of its served STA(s) according to the interference level(s) caused by the transmissions of AP1. Under the proposed scheme, AP1 may perform nulling toward STA0 when AP1 joins PPDU transmission(s) in the LCBF MAP. The LCBF MAP scheme may be applied in any one of the TXOP sharing procedures shown in FIG. 2~FIG. 4.

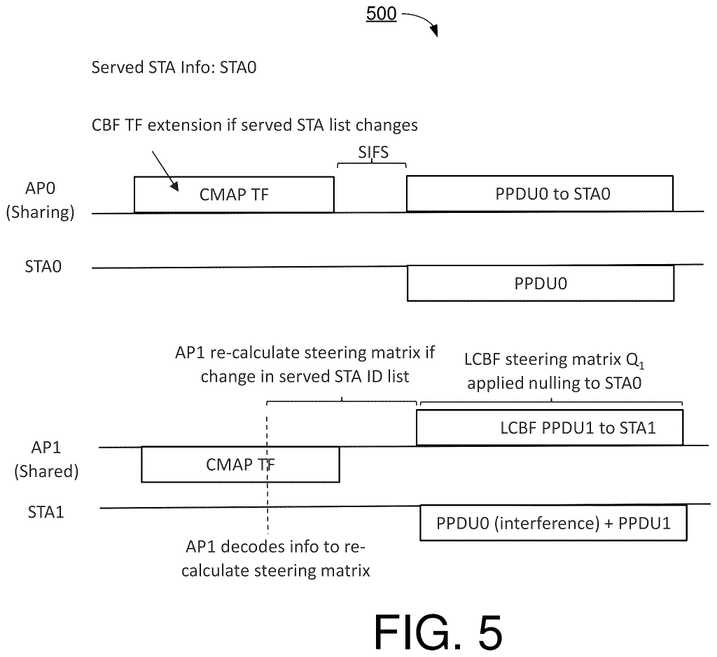

FIG. 5 illustrates an example scenario 500 under a proposed scheme in accordance with the present disclosure. Scenario 500 may pertain to a MAP-LCBF scenario. Referring to FIG. 5, a CMAP TF transmitted by the sharing AP (e.g., AP0) may support MAP-LCBF PPDU transmissions and may contain the following information: (a) a list of shared AP(s) indicating the shared AP(s) (e.g., AP1) that will participate in LCBF PPDU transmission; and (b) a list of served STA(s) indicating the STA(s) (e.g., STA0) to which the shared AP needs to null its transmission. In case that it is the first PPDU in a LCBF transmission of there is a change in the list of served STAs, a CBF TF extension may be included in the CMAP TF to allow each shared AP to update its steering matrix. In case that CBF TF extension in the CMAP TF is not included or not long enough for shared APs to complete steering matrix recalculation, each shared APs may delay its PPDU transmission as shown in FIG. 4. Upon receiving the CMAP TF, each shared AP (e.g., AP1) may null its transmission power toward STAs in the list of served STAs (e.g., STA0), and the shared AP may recalculate its steering matrix if necessary.

Under the proposed scheme, there may be several benefits provided by the proposed asymmetric CBF (or LCBF) scheme. For instance, the sharing AP (e.g., AP0) may transmit adequate power to maintain its data rate since it does not need to reduce interference caused to STA(s) served by the shared AP (e.g., STA1) or reduce its number of spatial streams to perform nulling toward STA1. Additionally, the shared AP (e.g., AP1) may perform nulling toward the STA(s) served by the sharing AP (e.g., STA0) to ensure its participation in the LCBF MAP transmission does not degrade the performance of AP0. In case that AP0 detects that AP1 does not perform nulling well, or that AP0 detects too much performance degradation due to the LCBF transmission by AP1, AP0 may stop the TXOP sharing with AP1. Moreover, even though illustrated in the scenarios of parts (C) and (D) of FIG. 1, which is suitable for application of LCBF, LCBF may also be applied in the scenario of part (B) of FIG. 1 for the benefit of a simplified CMAP procedure. In the worst case, if the different scenarios are not distinguished, the proposed LCBF may still be applied for the benefit of simplified CMAP procedure comparing to CBF or for improved throughput comparing to CSR.

Furthermore, LCBF may offer simplified MAP coordination between a sharing AP and shared AP(s) comparing to CBF. In CBF, every time there is a change of shared AP(s) or their target STAs during a CBF transmission, the shared APs need to report such a change to the sharing AP. Moreover, the sharing AP may need to recalculate its steering matrixes in order to perform nulling. The sharing AP may incur a lot of burden and suffer throughput loss in order to allow other APs to join CBF to share its TXOP. In LCBF, the sharing AP (e.g., AP0) does not need to perform nulling and does not need to reduce data rate to serve its targeted STAs. The shared AP (e.g., AP1) does not need to report to the sharing AP any changes in its served STA list. The sharing AP does not need to recalculate steering matrix as long as there is no changes in its served STA list. The shared AP obtains information of the sharing AP's served STAs from CMAP TF and recalculates its steering matrix when necessary. Comparing to CBF, the sharing AP may suffer much less penalty in LCBF. This may be considered much fairer to the sharing AP and, thereby, encourage it to share its TXOP with other APs with nulling capability.

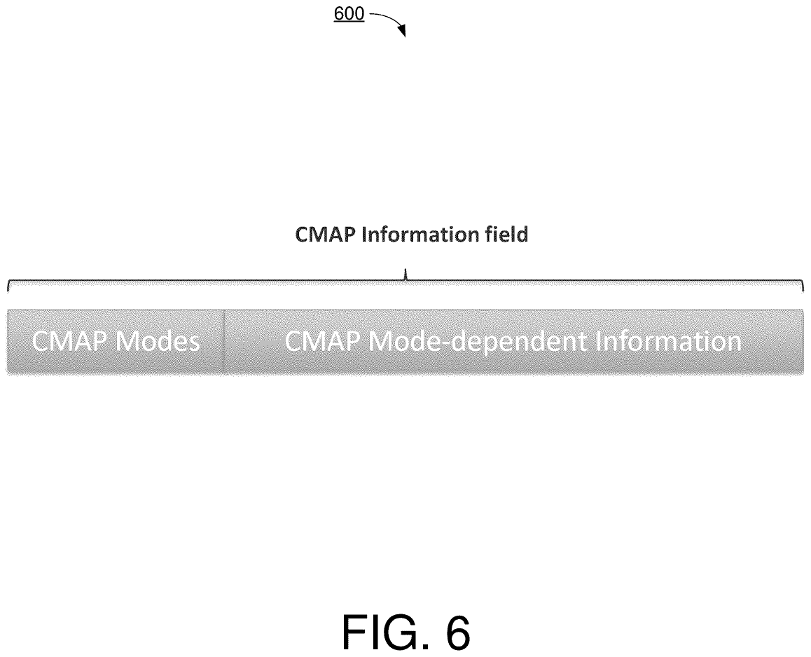

FIG. 6 illustrates an example design 600 under a proposed scheme in accordance with the present disclosure. Design 600 may pertain to CMAP modes and signaling. Under the proposed scheme, CMAP modes (or CMAP coordination modes) may include, for example and without limitation, coordinated time-division multiple access (C-TDMA), CSR, CBF and LCBF (or asymmetric CBF). Signaling of CMAP modes may be carried in the CMAP TF in the example scenarios shown in FIG. 2~FIG. 4. Referring to FIG. 6, a CMAP Information field may be added in the CMAP trigger frame to signal CMAP coordination modes and mode-dependent information. The CMAP Information field in the CMAP TF may include a number of subfields including, for example and without limitation, a CMAP Modes subfield and a CMAP Mode-dependent Information subfield. The CMAP Modes subfield may indicate one of the following CMAP modes: C-TDMA, CSR, CBF, and LCBF (or asymmetric CBF). The CMAP Mode-dependent Information subfield may include PPDU transmission requirements for a CMAP mode indicated in the CMAP Modes subfield. As a first signaling example, for C-TDMA, the CMAP Mode-dependent Information subfield may include Shared AP Info if it is not indicated in other fields of the CMAP TF. As a second signaling example, for CSR, the CMAP Mode-dependent Information subfield may include Shared AP Info (if it is not indicated in other fields of the CMAP TF) and transmission power information of sharing AP and shared AP(s). As a third signaling example, for LCBF, the CMAP Mode-dependent Information subfield may include Shared AP Info if it is not indicated in other fields of the CMAP TF. Information indicated for the sharing AP may include, for example and without limitation, ID information, transmission power information, targeted STA ID information, PPDU length, and resource units (RUs) and a length of a Trigger Based Block Ack(TBBA) of its one or more targeted STAs. Information indicated for each shared AP may include, for example and without limitation, ID information, transmission power information, CBF TF extension, transmission nulling information, PPDU length, and RUs and length for TBBA of its targeted STAs. As a fourth example, for CBF, the CMAP Mode-dependent Information subfield may include, for example and without limitation, ID information, transmission power information, targeted STA ID information, transmission nulling information, PPDU length, and RUs and length for TBBA of its targeted STAs. For each shared AP, the CMAP Mode-dependent Information subfield may include, for example and without limitation, ID information, transmission power information, targeted STA ID information, CBF TF extension, transmission nulling information, PPDU length, and RUs and length for TBBA of its targeted STAs.

Under the proposed scheme, the CMAP Information field may be added to the STA (e.g., shared AP) Info field in the CMAP TF (e.g., each CMAP Information field being designated to each shared AP). As a first example, AP0 may be sharing its TXOP with AP1, with the CMAP mode being CSR and transmission power information being signaled in the CMAP Information field for AP1, AP1 may perform CSR MAP with AP0 following transmission power requirement. As a second example, AP0 may be sharing its TXOP with AP1, with CMAP mode being LCBF and transmission power information being signaled in the CMAP Information field for AP1, AP1 may perform LCBF MAP with AP0 following transmission power requirement. As a third example, AP0 may be sharing its TXOP with AP1 and another shared AP (e.g., AP2), with CMAP mode being CSR in the CMAP Information field for AP1 and CMAP mode being LCBF in the CMAP Information field for AP2, AP1 may perform CSR MAP with AP0 while AP2 may perform LCBF with AP0 by nulling transmission to the served/targeted STAs of AP0 and AP1 (as listed in the respective served STA list). Moreover, the CMAP Information fields may be included in the CMAP TF for each RU of the sharing AP.

In CBF, which is one of the possible transmission schemes for CMAP systems in Wi-Fi, each AP steers its transmission toward its targeted STA(s) while nulling the targeted STA(s) of other AP(s). This would allow simultaneous transmissions by multiple APs with reduced interferences to each other's targeted STA(s). However, there are some difficulties associated with CBF. For instance, the TXOP owner (e.g., sharing AP) that initiates a CBF transmission procedure needs to know the most recent buffer status of an overlapping basic service set (OBSS) AP (e.g., shared AP) to identify which STA the shared AP has buffered data. The sharing AP also needs to have sounding feedback from the targeted STA(s) in the OBSS for the sharing AP to perform nulling. Additionally, the sharing AP also needs to ascertain which STA(s) the shared AP is transmitting to so as to provide nulling to the targeted STA(s). This is necessary before the sharing AP initiates the CBF procedure. These operations require more frequent frame exchanges between the sharing AP and shared APs, thereby resulting in higher overhead which is undesirable. Therefore, LCBF may be utilized to simplify the CMAP procedure.

Different from CBF, in LCBF, the sharing AP may transmit to its own STA(s) without providing nulling for other targeted STA(s) in the OBSS. On the positive side, less information would need to be exchanged between the APs (hence less overhead). Conversely, on the negative side, the transmission from a shared AP to its targeted STA(s) may suffer from interference from the sharing AP (due to no nulling), and this may lead to lower system performance. Therefore, a CBF variation with a simplified transmission procedure and good performance would be beneficial.

Under a proposed scheme in accordance with the present disclosure, a new variation of CBF (herein interchangeably referred to as “partial CBF” and/or “opportunistic CBF”) may be utilized such that the sharing AP may, based on existing information, select one or more target STAs in a shared BSS/OBSS to provide nulling. Under the proposed scheme, a shared AP may still need to null the targeted STA(s) of the sharing AP when participating in a CBF transmission, which is the same as a regular CBF procedure. The shared AP may either transmit to the targeted STA(s) specified by the sharing AP (with nulling from the sharing AP) or to one or more other STAs with more interference. When the shared AP transmits to the STA(s) specified by the sharing AP, the target STA(s) may suffer less interference from the sharing AP, and the system performance may remain the same as that under a regular CBF procedure. When the shared AP transmits to STA(s) not specified by the sharing AP, since the sharing AP does not provide nulling for such STA(s), the target STA(s) may suffer more interference and the system performance may be reduced or otherwise negatively impacted (e.g., to be close to that under LCBF).

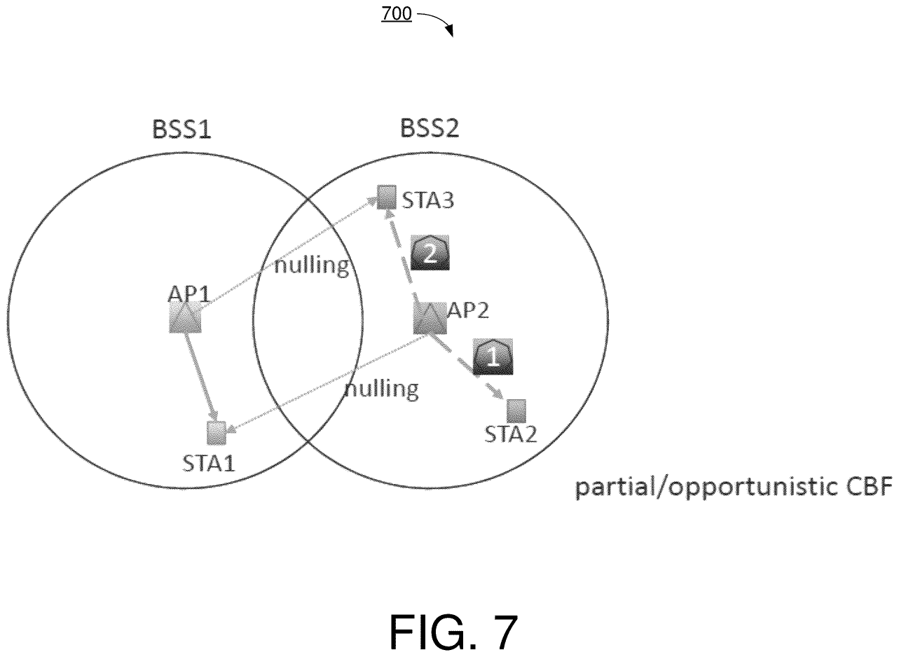

Under the proposed scheme, the sharing AP may not be required to obtain the most recent buffer status or other information from the shared AP(s) before a CBF transmission starts. Accordingly, there may be less frame exchange and less overhead than with a regular CBF. FIG. 7 illustrates an example scenario 700 of partial/opportunistic CBF under the proposed scheme. Referring to FIG. 7, a sharing AP (e.g., AP1) may initiate a partial/opportunistic CBF transmission by sending data to its own STA (e.g., STA1) while selecting and performing nulling toward a target STA (e.g., STA3) of a shared AP (e.g., AP2). The shared AP (e.g., AP2) may provide nulling for STA1 and choose one of two options. Under a first option, the shared AP may transmit to another target STA (e.g., STA2) with STA2 suffering more interference from AP1 (since STA2 is not selected by AP1 and no nulling is provided by AP1 toward STA2). Under a second option, the shared AP may transmit to STA3 with less interference as AP1 selects and provides nulling toward STA3.

### Illustrative Implementations

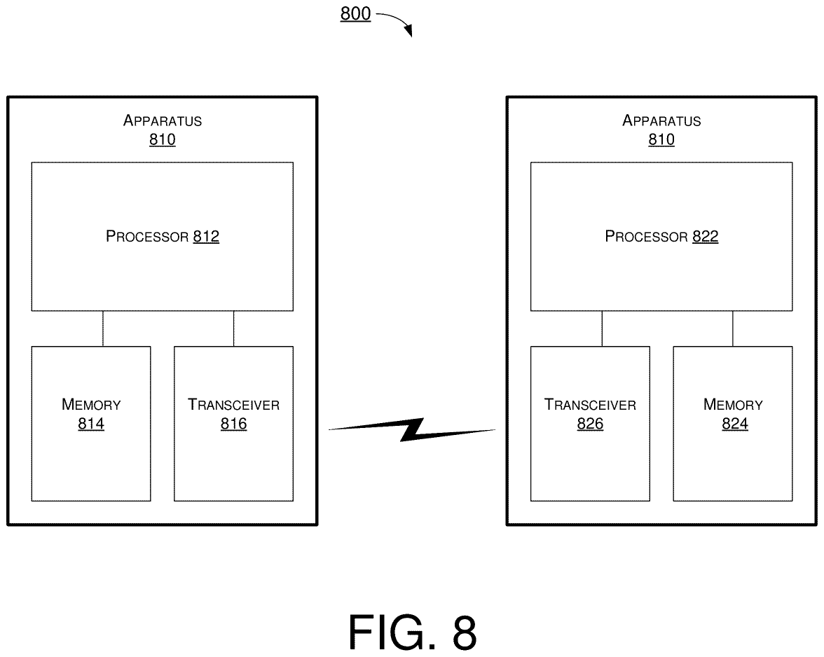

FIG. 8 illustrates an example system 800 having at least an example apparatus 810 and an example apparatus 820 in accordance with an implementation of the present disclosure. Each of apparatus 810 and apparatus 820 may perform various functions to implement schemes, techniques, processes and methods described herein pertaining to asymmetric (or lightly) CBF MAP schemes in wireless communications, including the various schemes described above with respect to various proposed designs, concepts, schemes, systems and methods described above as well as processes described below. For instance, apparatus 810 may be implemented in AP0 and apparatus 820 may be implemented in AP1, or vice versa.

Each of apparatus 810 and apparatus 820 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 810 and apparatus 820 may be implemented in a smartphone, a smart watch, a personal digital assistant, a digital camera, or a computing equipment such as a tablet computer, a laptop computer or a notebook computer. Each of apparatus 810 and apparatus 820 may also be a part of a machine type apparatus, which may be an IoT apparatus such as an immobile or a stationary apparatus, a home apparatus, a wire communication apparatus or a computing apparatus. For instance, each of apparatus 810 and apparatus 820 may be implemented in a smart thermostat, a smart fridge, a smart door lock, a wireless speaker or a home control center. When implemented in or as a network apparatus, apparatus 810 and/or apparatus 820 may be implemented in a network node, such as an AP in a WLAN.

In some implementations, each of apparatus 810 and apparatus 820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 810 and apparatus 820 may be implemented in or as a STA or an AP. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below in the interest of simplicity and brevity.

In one aspect, each of processor 812 and processor 822 may be implemented in the form of one or more single-core processors, one or more multi-core processors, one or more RISC processors or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed for asymmetric (or lightly) CBF MAP schemes in wireless communications in accordance with various implementations of the present disclosure.

In some implementations, apparatus 810 may also include a transceiver 816 coupled to processor 812. Transceiver 816 may include a transmitter capable of wirelessly transmitting and a receiver capable of wirelessly receiving data. In some implementations, apparatus 820 may also include a transceiver 826 coupled to processor 822. Transceiver 826 may include a transmitter capable of wirelessly transmitting and a receiver capable of wirelessly receiving data. It is noteworthy that, although transceiver 816 and transceiver 826 are illustrated as being external to and separate from processor 812 and processor 822, respectively, in some implementations, transceiver 816 may be an integral part of processor 812 as a system on chip (SoC), and transceiver 826 may be an integral part of processor 822 as a SoC.

In some implementations, apparatus 810 may further include a memory 814 coupled to processor 812 and capable of being accessed by processor 812 and storing data therein. In some implementations, apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810, as AP0, and apparatus 820, as AP1, is provided below in the context of example processes 900, 1000 and 1100. It is noteworthy that, although a detailed description of capabilities, functionalities and/or technical features of one of apparatus 810 and apparatus 820 is provided below, the same may be applied to the other of apparatus 810 and apparatus 820 although a detailed description thereof is not provided solely in the interest of brevity. It is also noteworthy that, although the example implementations described below are provided in the context of WLAN, the same may be implemented in other types of networks.

### Illustrative Processes

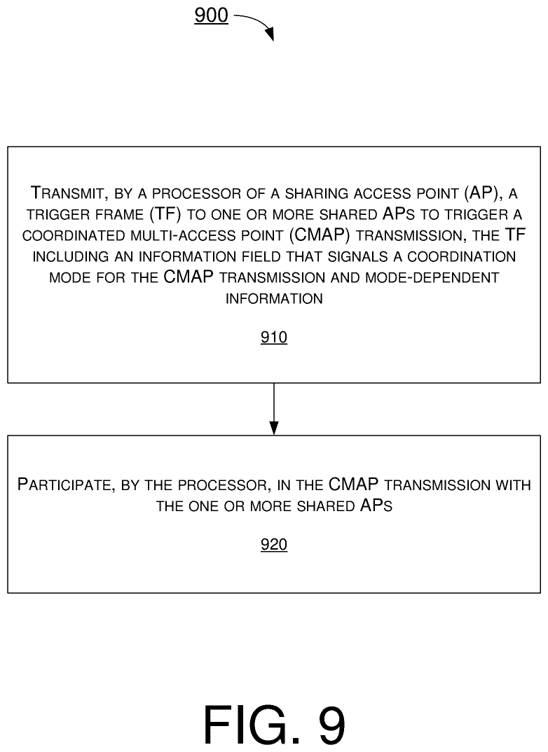

FIG. 9 illustrates an example process 900 in accordance with an implementation of the present disclosure. Process 900 may represent an aspect of implementing various proposed designs, concepts, schemes, systems and methods described above. More specifically, process 900 may represent an aspect of the proposed concepts and schemes pertaining to asymmetric (or lightly) CBF MAP schemes in wireless communications in accordance with the present disclosure. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively, in a different order. Furthermore, one or more of the blocks/sub-blocks of process 900 may be executed repeatedly or iteratively. Process 900 may be implemented by or in apparatus 810 and apparatus 820 as well as any variations thereof. Solely for illustrative purposes and without limiting the scope, process 900 is described below in the context of apparatus 810 implemented in or as AP0 (functioning as a sharing AP) and apparatus 820 implemented in or as AP1 (functioning as a shared AP) of a wireless network such as a WLAN in network environment 100 in accordance with one or more of IEEE 802.11 standards. Process 900 may begin at block 910.

At 910, process 900 may involve processor 812 of apparatus 810 transmitting, via transceiver 816, a TF to one or more shared APs to trigger a coordinated multi-access point (CMAP) transmission. The TF may include an information field that signals a coordination mode for the CMAP transmission and mode-dependent information. Process 900 may proceed from 910 to 920.

At 920, process 900 may involve processor 822 participating, via transceiver 816, in the CMAP transmission with the one or more shared APs.

In some implementations, in participating in the CMAP transmission, process 900 may involve processor 812 transmitting a PPDU to one or more STAs served by the sharing AP without performing nulling toward other STAs served by the one or more shared APs. Moreover, transmission by each of the one or more shared APs to each of their targeted STAs may be nulled toward the one or more STAs served by the sharing AP responsive to the one or more shared APs participating in the CMAP transmission.

In some implementations, in participating in the CMAP transmission, process 900 may involve processor 812 participating in a partial or opportunistic CBF transmission by selecting, based on existing information, one or more but not all target STAs in a shared BSS/OBSS to provide nulling.

In some implementations, a CMAP Mode subfield of a CMAP Information field in the TF may signal the coordination mode for the CMAP transmission as being one of the following: (1) C-TDMA; (2) CSR; (3) CBF; and (4) asymmetric CBF (or LCBF).

In some implementations, responsive to the coordination mode for the CMAP transmission being the C-TDMA, a Mode-dependent Information subfield of the CMAP Information field may include information on the one or more shared APs.

In some implementations, responsive to the coordination mode for the CMAP transmission being the CSR, a Mode-dependent Information subfield of the CMAP Information field may include: (a) information on the one or more shared APs; (b) information on a transmission power of the sharing AP; and (c) information on a transmission power of each of the one or more shared APs.

In some implementations, responsive to the coordination mode for the CMAP transmission being the CBF, a Mode-dependent Information subfield of the CMAP Information field may include information for the sharing AP comprising: (a) an ID of the sharing AP; (b) a transmission power of the sharing AP; (c) an ID of each of the one or more served STAs; (d) transmission nulling information; (e) a length of a PPDU transmitted by the sharing AP; and (f) information on RUs and a length of a TBBA of the one or more served STAs.

In some implementations, responsive to the coordination mode for the CMAP transmission being the CBF, a Mode-dependent Information subfield of the CMAP Information field may include information for each of the one or more shared APs comprising: (a) an ID of a respective shared AP; (b) a transmission power of the respective shared AP; (c) an ID of each of one or more STAs served by the respective shared AP; (d) transmission nulling information; (e) a length of a PPDU transmitted by the respective shared AP; and (f) information on RUs and a length of a TBBA of the one or more STAs served by the respective shared AP.

In some implementations, responsive to the coordination mode for the CMAP transmission being the asymmetric CBF, a Mode-dependent Information subfield of the CMAP Information field may include information for the sharing AP comprising: (a) an ID of the sharing AP; (b) a transmission power of the sharing AP; (c) an ID of each of the one or more served STAs; (d) a length of a PPDU transmitted by the sharing AP; and (e) information on RUs and a length of a TBBA of the one or more served STAs.

In some implementations, responsive to the coordination mode for the CMAP transmission being the asymmetric CBF, a Mode-dependent Information subfield of the CMAP Information field may include information for each of the one or more shared APs comprising: (a) an ID of a respective shared AP; (b) a transmission power of the respective shared AP; (c) a CBF trigger frame extension; (d) transmission nulling information; (e) a length of a PPDU transmitted by the respective shared AP; and (f) information on RUs and a length of a TBBA of the one or more STAs served by the respective shared AP.

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to asymmetric (or lightly) CBF MAP schemes in wireless communications in accordance with the present disclosure. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 810 and apparatus 820 as well as any variations thereof. Solely for illustrative purposes and without limiting the scope, process 1000 is described below in the context of apparatus 810 implemented in or as AP0 (functioning as a sharing AP) and apparatus 820 implemented in or as AP1 (functioning as a shared AP) of a wireless network such as a WLAN in network environment 100 in accordance with one or more of IEEE 802.11 standards. Process 1000 may begin at block 1010.

At 1010, process 1000 may involve processor 822 of apparatus 820 receiving, via transceiver 826, a TF from a sharing AP that triggers a CMAP transmission. The TF may include an information field that signals a coordination mode for the CMAP transmission and mode-dependent information. Process 1000 may proceed from 1010 to 1020.

At 1020, process 1000 may involve processor 822 participating, via transceiver 826, in the CMAP transmission with the sharing AP.

In some implementations, in participating in the CMAP transmission, process 1000 may involve processor 822 transmitting a PPDU to one or more STAs served by the shared AP by performing nulling toward one or more STAs served by the sharing AP. Moreover, transmission by the sharing AP to the one or more STAs served by the sharing AP may be not nulled toward the one or more STAs served by the shared AP.

In some implementations, in participating in the CMAP transmission, process 1000 may involve processor 822 participating in a partial or opportunistic CBF transmission by: (1) performing nulling toward one or more STAs served by the sharing AP; and (2) transmitting to either: (a) a first STA selected by the sharing AP and to which nulling is provided by the sharing AP (e.g., STA3 in FIG. 7); or (b) a second STA not selected by the sharing AP and to which no nulling is provided by the sharing AP (e.g., STA2 in FIG. 7).

In some implementations, a CMAP Modes subfield of a CMAP Information field in the TF may signal the coordination mode for the CMAP transmission as being one of the following: (1) C-TDMA; (2) CSR; (3) CBF; and (4) asymmetric CBF (or LCBF).

In some implementations, responsive to the coordination mode for the CMAP transmission being the C-TDMA, a Mode-dependent Information subfield of the CMAP Information field may include information on the one or more shared APs.

In some implementations, responsive to the coordination mode for the CMAP transmission being the CSR, a Mode-dependent Information subfield of the CMAP Information field may include: (a) information on the one or more shared APs; (b) information on a transmission power of the sharing AP; and (c) information on a transmission power of each of the one or more shared APs.

In some implementations, responsive to the coordination mode for the CMAP transmission being the CBF, a Mode-dependent Information subfield of the CMAP Information field may include information for the sharing AP comprising: (a) an ID of the sharing AP; (b) a transmission power of the sharing AP; (c) an ID of each of the one or more served STAs; (d) transmission nulling information; (e) a length of a PPDU transmitted by the sharing AP; and (f) information on RUs and a length of a TBBA of the one or more served STAs.

In some implementations, responsive to the coordination mode for the CMAP transmission being the CBF, a Mode-dependent Information subfield of the CMAP Information field may include information for each of the one or more shared APs comprising: (a) an ID of a respective shared AP; (b) a transmission power of the respective shared AP; (c) an ID of each of one or more STAs served by the respective shared AP; (d) transmission nulling information; (e) a length of a PPDU transmitted by the respective shared AP; and (f) information on RUs and a length of a TBBA of the one or more STAs served by the respective shared AP.

In some implementations, responsive to the coordination mode for the CMAP transmission being the asymmetric CBF, a Mode-dependent Information subfield of the CMAP Information field may include information for the sharing AP comprising: (a) an ID of the sharing AP; (b) a transmission power of the sharing AP; (c) an ID of each of the one or more served STAs; (d) a length of a PPDU transmitted by the sharing AP; and (e) information on RUs and a length of a TBBA of the one or more served STAs.

In some implementations, responsive to the coordination mode for the CMAP transmission being the asymmetric CBF, a Mode-dependent Information subfield of the CMAP Information field may include information for each of the one or more shared APs comprising: (a) an ID of a respective shared AP; (b) a transmission power of the respective shared AP; (c) a CBF trigger frame extension; (d) transmission nulling information; (e) a length of a PPDU transmitted by the respective shared AP; and (f) information on RUs and a length of a TBBA of the one or more STAs served by the respective shared AP.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a sharing access point (AP), a trigger frame (TF) to one or more shared APs to trigger a coordinated multi-access point (CMAP) transmission; and
participating, by the processor, in the CMAP transmission with the one or more shared APs,
wherein the TF comprises an information field that signals a coordination mode for the CMAP transmission and mode-dependent information.

2. The method of claim 1, wherein the participating in the CMAP transmission comprises transmitting a physical-layer protocol data unit (PPDU) to one or more stations (STAs) served by the sharing AP without performing nulling toward other STAs served by the one or more shared APs, and wherein transmission by each of the one or more shared APs to each of their targeted STAs is nulled toward the one or more STAs served by the sharing AP responsive to the one or more shared APs participating in the CMAP transmission.

3. The method of claim 1, wherein the participating in the CMAP transmission comprises participating in a partial or opportunistic coordinated beam forming (CBF) transmission by selecting, based on existing information, one or more but not all target stations (STAs) in a shared basic service set (BSS) or overlapping basic service set (OBSS) to provide nulling.

4. The method of claim 1, wherein a CMAP Mode subfield of a CMAP Information field in the TF signals the coordination mode for the CMAP transmission as being one of:
coordinated time-division multiple access (C-TDMA);
coordinated spatial reuse (CSR);
coordinated beamforming (CBF); and
asymmetric CBF.

5. The method of claim 4, wherein, responsive to the coordination mode for the CMAP transmission being the C-TDMA, a Mode-dependent Information subfield of the CMAP Information field comprises information on the one or more shared APs.

6. The method of claim 4, wherein, responsive to the coordination mode for the CMAP transmission being the CSR, a Mode-dependent Information subfield of the CMAP Information field comprises:
information on the one or more shared APs;
information on a transmission power of the sharing AP; and
information on a transmission power of each of the one or more shared APs.

7. The method of claim 4, wherein, responsive to the coordination mode for the CMAP transmission being the CBF, a Mode-dependent Information subfield of the CMAP Information field comprises information for the sharing AP comprising:
an identification (ID) of the sharing AP;
a transmission power of the sharing AP;
an ID of each of the one or more served STAs;
transmission nulling information;
a length of a physical-layer protocol data unit (PPDU) transmitted by the sharing AP; and
information on resource units (RUs) and a length of a Trigger Based Block Ack (TBBA) of the one or more served STAs.

8. The method of claim 4, wherein, responsive to the coordination mode for the CMAP transmission being the CBF, a Mode-dependent Information subfield of the CMAP Information field comprises information for each of the one or more shared APs comprising:
an identification (ID) of a respective shared AP;
a transmission power of the respective shared AP;
an ID of each of one or more STAs served by the respective shared AP;
transmission nulling information;
a length of a physical-layer protocol data unit (PPDU) transmitted by the respective shared AP; and
information on resource units (RUs) and a length of a Trigger Based Block Ack (TBBA) of the one or more STAs served by the respective shared AP.

9. The method of claim 4, wherein, responsive to the coordination mode for the CMAP transmission being the asymmetric CBF, a Mode-dependent Information subfield of the CMAP Information field comprises information for the sharing AP comprising:
an identification (ID) of the sharing AP;
a transmission power of the sharing AP;
an ID of each of the one or more served STAs;
a length of a physical-layer protocol data unit (PPDU) transmitted by the sharing AP; and
information on resource units (RUs) and a length of a Trigger Based Block Ack (TBBA) of the one or more served STAs.

10. The method of claim 4, wherein, responsive to the coordination mode for the CMAP transmission being the asymmetric CBF, a Mode-dependent Information subfield of the CMAP Information field comprises information for each of the one or more shared APs comprising:
an identification (ID) of a respective shared AP;
a transmission power of the respective shared AP;
a CBF trigger frame extension;
transmission nulling information;
a length of a physical-layer protocol data unit (PPDU) transmitted by the respective shared AP; and
information on resource units (RUs) and a length of a Trigger Based Block Ack (TBBA) of the one or more STAs served by the respective shared AP.

11. A method, comprising:
receiving, by a processor of a shared access point (AP), a trigger frame (TF) from a sharing AP that triggers a coordinated multi-access point (CMAP) transmission; and
participating, by the processor, in the CMAP transmission with the sharing AP,
wherein the TF comprises an information field that signals a coordination mode for the CMAP transmission and mode-dependent information.

12. The method of claim 11, wherein the participating in the CMAP transmission comprises transmitting a physical-layer protocol data unit (PPDU) to one or more stations (STAs) served by the shared AP by performing nulling toward one or more STAs served by the sharing AP, and wherein transmission by the sharing AP to the one or more STAs served by the sharing AP is not nulled toward the one or more STAs served by the shared AP.

13. The method of claim 11, wherein the participating in the CMAP transmission comprises participating in a partial or opportunistic coordinated beam forming (CBF) transmission by:
performing nulling toward one or more stations (STAs) served by the sharing AP; and
transmitting to either:
one or more STA selected by the sharing AP and to which nulling is provided by the sharing AP; or
one or more STA not selected by the sharing AP and to which no nulling is provided by the sharing AP.

14. The method of claim 11, wherein a CMAP Modes subfield of a CMAP Information field in the TF signals the coordination mode for the CMAP transmission as being one of:
coordinated time-division multiple access (C-TDMA);
coordinated spatial reuse (CSR);
coordinated beamforming (CBF); and
asymmetric CBF.

15. The method of claim 14, wherein, responsive to the coordination mode for the CMAP transmission being the C-TDMA, a Mode-dependent Information subfield of the CMAP Information field comprises information on the one or more shared APs.

16. The method of claim 14, wherein, responsive to the coordination mode for the CMAP transmission being the CSR, a Mode-dependent Information subfield of the CMAP Information field comprises:
information on the one or more shared APs;
information on a transmission power of the sharing AP; and
information on a transmission power of each of the one or more shared APs.

17. The method of claim 14, wherein, responsive to the coordination mode for the CMAP transmission being the CBF, a Mode-dependent Information subfield of the CMAP Information field comprises information for the sharing AP comprising:
an identification (ID) of the sharing AP;
a transmission power of the sharing AP;
an ID of each of the one or more served STAs;
transmission nulling information;
a length of a physical-layer protocol data unit (PPDU) transmitted by the sharing AP; and
information on resource units (RUs) and a length of a Trigger Based Block Ack (TBBA) of the one or more served STAs.

18. The method of claim 14, wherein, responsive to the coordination mode for the CMAP transmission being the CBF, a Mode-dependent Information subfield of the CMAP Information field comprises information for each of the one or more shared APs comprising:
an identification (ID) of a respective shared AP;
a transmission power of the respective shared AP;
an ID of each of one or more STAs served by the respective shared AP;
transmission nulling information;
a length of a physical-layer protocol data unit (PPDU) transmitted by the respective shared AP; and
information on resource units (RUs) and a length of a Trigger Based Block Ack (TBBA) of the one or more STAs served by the respective shared AP.

19. The method of claim 14, wherein, responsive to the coordination mode for the CMAP transmission being the asymmetric CBF, a Mode-dependent Information subfield of the CMAP Information field comprises information for the sharing AP comprising:
an identification (ID) of the sharing AP;
a transmission power of the sharing AP;
an ID of each of the one or more served STAs;
a length of a physical-layer protocol data unit (PPDU) transmitted by the sharing AP; and
information on resource units (RUs) and a length of a Trigger Based Block Ack (TBBA) of the one or more served STAs.

20. The method of claim 14, wherein, responsive to the coordination mode for the CMAP transmission being the asymmetric CBF, a Mode-dependent Information subfield of the CMAP Information field comprises information for each of the one or more shared APs comprising:
an identification (ID) of a respective shared AP;
a transmission power of the respective shared AP;
a CBF trigger frame extension;
transmission nulling information;
a length of a physical-layer protocol data unit (PPDU) transmitted by the respective shared AP; and
information on resource units (RUs) and a length of a Trigger Based Block Ack (TBBA) of the one or more STAs served by the respective shared AP.
